(19) United States
(12) Patent Application Publication
(10) Pub. No.: US 2017/0074714 A1
(43) Pub. Date: Mar. 16, 2017

(54) LIQUID LEVEL SENSOR WITH LINEAR OUTPUT

(71) Applicant: Standex International Corporation, Salem, NH (US)

(72) Inventor: Dennis Dario Aschenbrenner, Singen (DE)

(73) Assignee: Standex International Corporation, Salem, NH (US)

(21) Appl. No.: 15/261,980

(22) Filed: Sep. 11, 2016

Related U.S. Application Data
(60) Provisional application No. 62/217,158, filed on Sep. 11, 2015.

(51) Int. Cl. G01F 23/72

(52) U.S. Cl. CPC G01F 23/72

(57) ABSTRACT

A liquid level sensor that provides digital signal processing for transforming a magnetic field into a continuous linear output signal that corresponds to the level of liquid within a vessel that is being monitored. The invention uses 3D field sensors for decompensating unwanted interference caused by electric drives or the earth's magnetic field or other magnetic fields caused wires or magnets. The sensor can also be combined with 3D accelerometer to optimize compensation of unwanted interference. The accelerometer always provides the center of the earth so that an angle of deflection of the liquid versus the horizontal can be determined and correct any faulty measured value of the liquid level. The invention is highly robust yet is low cost to manufacture.

This application claims benefit of U.S. Provisional Application Ser. No. 62/217,158, filed Sep. 11, 2015, pursuant to 35 USC §119(e).

### FIELD OF THE INVENTION

This invention relates to liquid level sensors, particularly liquid level sensors that provide a continuous linear output signal as the liquid level changes.

### BACKGROUND OF THE INVENTION

The use of a floating magnet for sensing a level of liquid is well known. However, prior art makes use of reed switches, which switch on and off when the proximity to the floating magnet changes. Representative of this type of device is disclosed in U.S. Pat. No. 8,549,911, issued to Rudd et al. on Oct. 8, 2013. This reference discloses a set of axially displaced magnetic sensing switches (reed switches) and a magnet on a float that may rise and fall on the level of the liquid to activate and deactivate the switches. However, there is not found or suggested in the prior art a device to replace reed switches with at least two 3D magnetic field sensors.

### SUMMARY OF THE INVENTION

It is an aspect of the invention to provide a liquid level sensor that provides digital signal processing for transforming a magnetic field into a continuous linear output signal that corresponds to the level of liquid within a vessel that is being monitored.

It is another aspect of the invention to provide a liquid level sensor that uses 3D field sensors for decompensating unwanted interference caused by electric drives or the earth's magnetic field or other magnetic fields caused wires or magnets. The sensor used in the invention is more sensitive to magnetic fields than a reed switch, thus, more noise that must be decompensated.

It is another aspect of the invention to provide a liquid level sensor that can be combined with a 3D accelerometer to optimize compensation of unwanted interference. The accelerometer always provides the center of the earth so that an angle of deflection of the liquid versus the horizontal can be determined and correct any faulty measured value of the liquid level.

It is still another aspect of the invention to provide a liquid level sensor that provides suppression of superimposed interference through an algorithm that is a basic subtraction and comparison of the measured values.

It is an aspect of the invention to provide a liquid level sensor that uses low cost sensors.

Another aspect of the invention is to provide a liquid level sensor that has technological simplification of the measurement procedure towards commonly known ones. It is still another aspect of the invention to provide a liquid level sensor that is highly robust.

Another aspect of the invention is to provide a liquid level sensor that requires no adjustment of individual sensors necessary due to signal processing.

Another aspect of the invention is to provide a liquid level sensor that provides greater spacing advantages over prior art designs.

It is an aspect of the invention to provide a liquid level sensor that has an algorithm for the analysis of the plausibility for a changing in the magnetic field and self-diagnostics. By measuring with at least two sensors, it is possible to determine if what is measured is correct and know if one sensor is not working properly. Self-diagnosis is very important for the automotive industry.

Another aspect of the invention is to provide a liquid level sensor that has highly sensitive magnetic field sensors to cover large measurement distances.

It is still another aspect of the invention to provide a liquid level sensor that provides an algorithm for a decompensation of a nonlinear change in the liquid level caused by a nonlinear shape of the tank containing the liquid that is to be measured.

Finally, it is an aspect of the invention to provide a liquid level sensor that uses an algorithm that accounts for decompensating transient changes of liquid level caused by slosh.

### BRIEF DESCRIPTION OF THE DRAWINGS

FIG. 1 is a schematic cross-sectional view of the liquid level sensor in accordance with the invention.

FIG. 2 is an illustration showing the reason why at least two magnetic field sensors are required.

FIG. 3 is an illustration showing the fields with a magnet between the two sensors.

FIG. 4 is an illustration of the sum and distance vectors at the sensors.

FIG. 5 is an illustration of a graph of magnitude versus position.

FIG. 6 is an illustration of the above graph with the measurement points indicated.

### DETAILED DESCRIPTION OF THE INVENTION

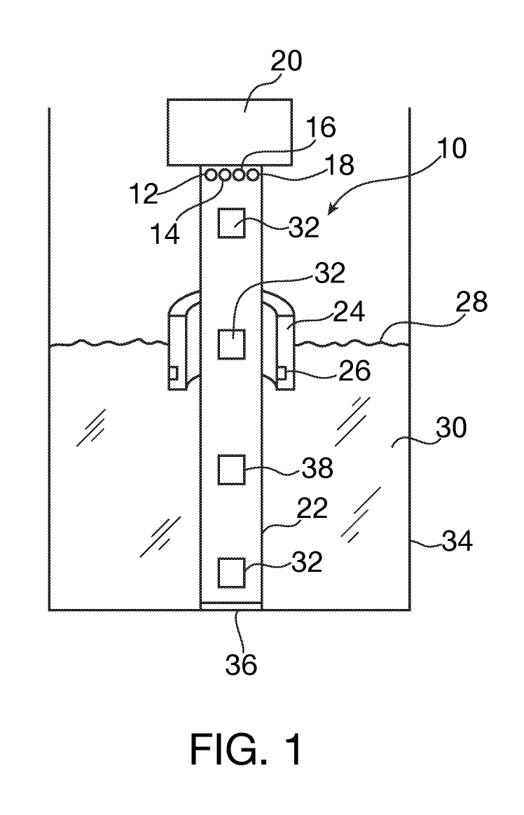

As shown in FIG. 1, invention 10, a liquid level sensor, is shown measuring level 28 of liquid 30 contained within vessel 34. Sensor 10 is mounted in vessel 34 by means of mounting cap 20 and bottom lid 36. Housing 22 extends between cap 20 and lid 36. While vessel 34 is shown as a cylinder, any shape vessel 34 would be suitable, even a nonlinear shaped tank.

Inside housing 22 is a printed circuit board (not shown) following the same configuration of housing 22. Again, housing 22 and its attached printed circuit board is shown as a cylinder but this shape is not essential and any cross-sectional shape, such as an oval, rectangle, that fits within vessel 34 could be used as long as float 24 can easily slide up and down housing 22 in response to changes in level 28.

Inside housing 22 is microprocessor 38. While microprocessor 38 is shown inside housing 22, microprocessor 38 could be inside vessel 34 or even outside vessel 34 as long as microprocessor 38 remains in electrical communication with rest of invention 10. The printed circuit board of invention 10 is powered by electrical connection 12 and ground 14. Outputs are analog output 16 and temperature output 18 if required.

Inside float 24 is ring magnet 26. Invention 10 is completed by providing a number of field sensors 32 within housing 22. While three field sensors are shown, as long as at least two are provided, invention 10 will work as intended. The exact number of field sensors 32 required would depend on the measurement length that is intended. A greater length will require a greater number of sensors cascaded. Field sensor 32 is preferably Model No. LSM303C as made by STMicroelectronics, Inc., however, other models having similar characteristics would be suitable.

By use of the magnetic field sensors instead of reed switches, a continuous output signal is obtained instead of fixed switching points. This signal could be either analog or digital, as desired. The sensors also can measure temperature, which is used to compensate tolerances of the magnet, which varies, over temperature. Invention 10 can also compensate to the changing density of liquid being measured, if necessary.

At least two sensors are required due to any interference or offset caused by another magnet, drive, etc. The value of the interference affects both sensors with an offset. Microprocessor 38 can determine the offset and subtract it in order to obtain the “real” values of the sensors needed to obtain an accurate output signal.

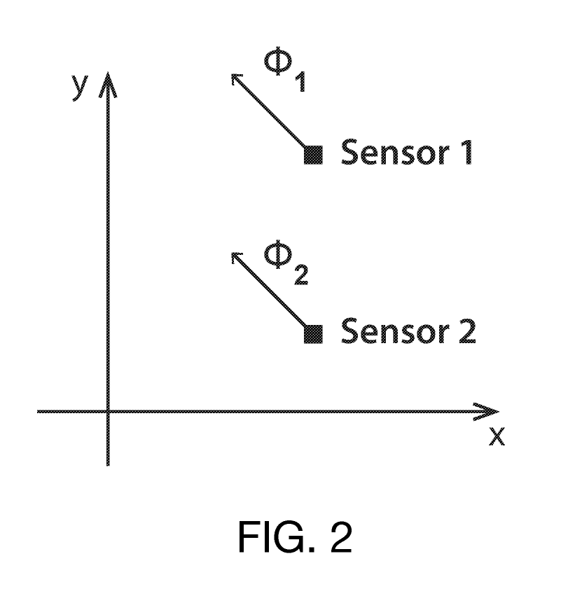

In operation, the invention uses an algorithm that assumes at least two magnetic field sensors. Referring to FIG. 2, the reason for requiring at least two magnetic field sensors is shown. The goal is to eliminate the earth's magnetic field whose magnetic field strength and direction (vector) depends on the position of the earth.

If the earth's magnetic field is measured with two sensors that are relatively close to one another, the same direction and strength of the field vectors φ₁ and φ₂ will be measured.

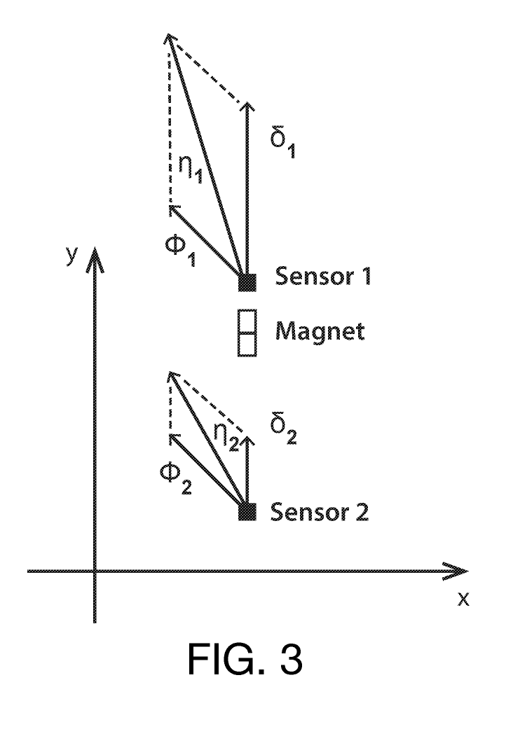

As shown in FIG. 3, the next step is to evaluate the measurement values of the sensors is a magnet that is placed between the two field sensors. In this case, the magnet is closer to sensor 1. This adds the bigger field vector δ₁ to sensor 1; additionally, this adds to the field vector of the earth's magnetic field. The field vector δ₂ is less in this case due to the longer distance to the magnet. Now, what is measured with the sensors is not two separated vectors. Rather, it is the sum of the earth's magnetic field and the magnet's field, η₁ at sensor 1 and η₂ at sensor 2.

Now the distance α₁ between vector sums η₁ and η₂ is measured. The theory behind this is as follows: If the offset changes, the distance between the vectors is only influenced by the magnet. If the offset at sensor 1 and sensor 2 is the same, the distance remains the same.

Until this point, we have neglected the third dimension. A vector will now be written in the form

$${a}^{->} = ( \begin{matrix}x \\ y \\ z\end{matrix} ) ,$$

which consists of three dimensions. The output signal of each sensor is also given in three dimensions. To measure the distance between \vec{η}₁ and \vec{η}₂ and shift sensor 1's “y” component, an amount c to create a virtual offset that imitates the real physical distance between sensor 1 and 2 is required, thus providing the following equation:

$$\vec{{η}_{1}} = ( \begin{matrix}x \\ y + ɛ \\ z\end{matrix} ) , \vec{{η}_{2}} = ( \begin{matrix}x \\ y \\ z\end{matrix} ) .$$

To calculate the distance between the vectors \vec{η}₁ and \vec{η}₂, use the following equation to calculate vector α₁

$$\vec{{α}_{1}} = \vec{{η}_{1}} - \vec{{η}_{2}} = ( \begin{matrix}x \\ y + ɛ \\ z\end{matrix} ) - ( \begin{matrix}x \\ y \\ z\end{matrix} ) .$$

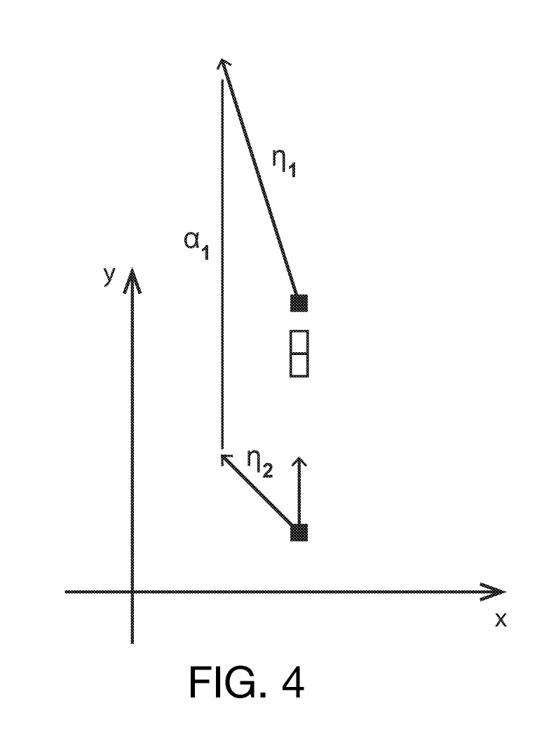

As shown in FIG. 4, we calculate the magnitude of this vector, which is a scalar using the following:

$$\vert \vec{{α}_{1}} \vert = \sqrt[2]{{x}^{2} + {y}^{2} + {z}^{2}}$$

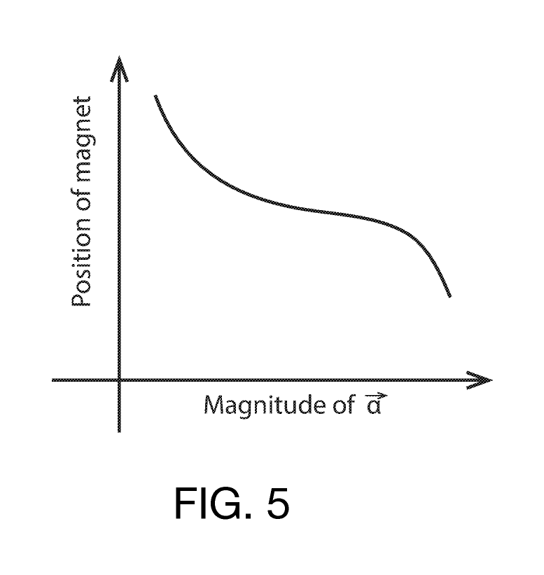

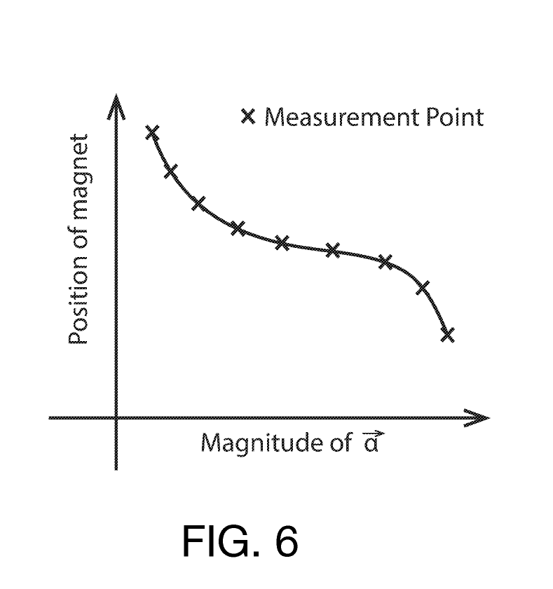

Now, referring to FIG. 5, a plot of this vector versus the magnet position yields the following. The measured values need to be linearized to create a linear output signal. This is accomplished via a linear piece-wise interpolation as shown in FIG. 6. However, a large amount of datapoints cannot be stored in the microcontroller due to its limited space. But, using a linear piece-wise interpolation, n number of points of the magnitude and position of the magnet are stored. Then, the derivatives between the points on the axis are calculated. For n datapoints, n−1 derivatives dX are obtained.

X [n]: x value of measurement point n

n: Number of Measurement points.

dX[n−1]: Derivative of 2 neighborhood measurement point dX[n]=X[n−1]−X[n]

X0: Starting Value (or X [0])

Afterwards, we assume that two neighborhood points can be represented by a straight line and the whole curve is integrated until the integrated value equals the measured value. Between two points, a second interval of points is introduced which is called samples k to increase the resolution. The total amount of actual Steps equals (n−1)*k. The following shows the pseudocode of the algorithm:

Step=0;

Samples=k;

Result=X0

m=Variable which stores the interval between two neighborhood datapoints

While (measured_value<intgreated_value)

{Step=Step+1;

m= [symbol] (Step/k);

Result=Result+dX[m]/k}

Although the present invention has been described with reference to certain preferred embodiments thereof, other versions are readily apparent to those of ordinary skill in the preferred embodiments contained herein.

What is claimed is:

1. A liquid level sensor comprising:
a vessel containing a liquid wherein the amount of said liquid within said vessel is highly variable over time;
a housing containing at least two magnetic field sensors rigidly affixed therein, wherein said housing is positionally affixed within said container;
a microprocessor in electrical communication with said at least two magnetic field sensors;
a float having a magnet wherein said float is associated with said housing so that said float can easily slide up or down on said housing in response to changes in the liquid level in said vessel; wherein the level of the liquid in said vessel is provided by an output signal obtained by the measurement values from said at least two sensors relative to magnetic field of said magnet.

2. The liquid level sensor of claim 1 wherein interference or offset caused by another magnet, drive or other device is determined by said microprocessor and then subtracted to provide an accurate output signal.

3. The liquid level sensor of claim 1 wherein said at least two sensors are required to eliminate the earth's magnetic field whose strength and vector direction depends on the position of the earth.

4. The liquid level sensor of claim 1 the exact number of said sensors corresponds to the measurement length that said liquid level sensor is required to measure, that is, a greater length requires a greater number of sensors.

5. The liquid level sensor of claim 1 wherein said vessel is any shape even a nonlinear shaped vessel.

6. The liquid level sensor of claim 1 wherein the cross-sectional shape of said housing is any shape as long as said float can easily slide up or down on said housing in response to changes in level of liquid in said vessel.

7. The liquid level sensor of claim 1 wherein said microprocessor is contained within said housing.

8. The liquid level sensor of claim 1 wherein said microprocessor is contained within said vessel.

9. The liquid level sensor of claim 1 wherein said microprocessor is outside of said vessel.

10. The liquid level sensor of claim 1 wherein said output signal is continuous and is digital.

11. The liquid level sensor of claim 1 wherein said output signal is continuous and is analog.

12. The liquid level sensor of claim 1 wherein said sensors measure temperature of the liquid in order to compensate tolerance of said magnet which varies with temperature.

13. The liquid level sensor of claim 1 said microprocessor provides for decompensation transient changes of liquid level caused by slosh of the liquid in said vessel.

14. The liquid level sensor of claim 1 wherein said microprocessor provides for a decompensation of a nonlinear change in the liquid level caused by said nonlinear shaped vessel.

15. The liquid level sensor of claim 1 where said liquid level sensor is combined with a 3D accelerometer to optimize compensation of unwanted interference.
